(19) United States
(12) Patent Application Publication
(10) Pub. No.: US 2019/0248353 A1
(43) Pub. Date: Aug. 15, 2019

(54) Solenoid Valve and Hydraulic Braking System for a Vehicle

(71) Applicant: Robert Bosch GmbH, Stuttgart (DE)

(72) Inventor: Dietmar Kratzer, Tamm (DE)

(21) Appl. No.: 16/331,839

(22) PCT Filed: Aug. 16, 2017
(86) PCT No.: PCT/EP2017/070742

§ 371 Date: Mar. 8, 2019

(30) Foreign Application Priority Data
Oct. 13, 2016 (DE) 10 2016 219 957.9

(51) Int. Cl. B60T 13/68

(52) U.S. Cl. CPC B60T 13/686; B60T 13/662

(57) ABSTRACT

A solenoid valve for a hydraulic braking system includes an armature that axially moves a plunger, which has a closing element, in the valve armature. A mechanical detent is formed between a fixed guide element, which is introduced into a guide sleeve, and the plunger, the detent device releasing the plunger when the plunger is in a de-energised closed position, such that a first restoring spring pushes the closing element sealingly into the valve seat to produce a sealing function, and said detent device fixes the plunger in a de-energised open position against the force of the first restoring spring in an axial detent position, such that the closing element is raised from the valve seat.

The invention proceeds from a solenoid valve for a hydraulic brake system according to the generic type of independent patent claim 1. The present invention also relates to a hydraulic brake system for a vehicle having a solenoid valve of said type.

The prior art has disclosed hydraulic brake systems for vehicles having a master brake cylinder, having a hydraulics unit and having multiple wheel brakes, which comprise various safety systems such as for example an anti-lock system (ABS), electronic stability program (ESP) etc., and which can perform various safety functions such as for example an anti-lock function, drive slip control (ASR) etc. By means of the hydraulics unit, open-loop and/or closed-loop control processes can be performed in the anti-lock system (ABS) or in the drive slip control system (ASR system) or in the electronic stability program system (ESP system) for the build-up of pressure or dissipation of pressure in the corresponding wheel brakes. To perform the open-loop and/or closed-loop control processes, the hydraulics unit comprises solenoid valves which are normally held in distinct positions owing to the oppositely acting forces “magnetic force”, “spring force” and “hydraulic force”. Accordingly, the valve types “open when electrically deenergized” and “closed when electrically deenergized” exist. These solenoid valves each comprise a solenoid assembly and a valve cartridge, which comprises a pole core, a guide sleeve connected to the pole core, an armature which is guided within the guide sleeve so as to be axially movable between a closed position and an open position counter to the force of a resetting spring and which has a plunger and has a closing element, and a valve sleeve which is connected to the guide sleeve and which has a valve seat. By means of the electrical energization of the solenoid assembly, a magnetic force is generated which, in the case of a solenoid valve which is open when electrically deenergized, moves the armature with the plunger and the closing element from the open position into the closed position, until the closing element abuts against the corresponding valve seat and seals off the latter. In the electrically deenergized state, the resetting spring moves the armature with the plunger and the closing element, and the closing element lifts off from the valve seat and opens up the latter. In the case of a solenoid valve which is closed when electrically deenergized, the electrical energization of the solenoid assembly causes the armature with the plunger and the closing element to be moved from the closed position into the open position, and the closing element lifts off from the valve seat and opens up the latter. If the electrical current is deactivated, then the resetting spring moves the solenoid armature with the closing element in the direction of the valve seat until the closing element abuts against the valve seat and seals off the latter. This electrical energization is associated with energy consumption, which is undesirable. Furthermore, the functional reliability or functional availability is not provided to the desired extent if the function is realized only by means of active electrical energization.

The laid-open specification DE 10 2007 051 557 A1 describes for example a solenoid valve, which is closed when electrically deenergized, for a slip-controlled hydraulic vehicle brake system. The solenoid valve comprises a hydraulic part, also referred to as valve cartridge, which is arranged partially in a stepped bore of a valve block, and an electrical part, which is formed substantially from a solenoid assembly which is fitted onto that part of the valve cartridge which projects out of the valve block. The solenoid assembly comprises a coil body with an electrical winding, a magnetic-flux-conducting coil casing, and a magnetic-flux-conducting ring-shaped disk. The hydraulic part has a guide sleeve, which at its end facing toward the electrical part is closed off by means of a pressed-in pole core which is welded in fluid-type fashion. In the guide sleeve, there is received a longitudinally displaceable armature which is supported by means of a restoring spring on the pole core. The armature has, averted from the pole core, a spherical closing body which is arranged in a depression. At the end averted from the pole core, a pot-shaped valve sleeve with a cylindrical shell and a base is pressed into the guide sleeve. The valve sleeve has, on the base, a passage and a hollow spherical valve seat which, with the closing body, forms a seat valve. By means of the seat valve, a fluidic connection between the passage on the base of the valve sleeve and at least one passage in the casing of the valve sleeve is configured to be switchable. Furthermore, on the outside of the shell of the valve sleeve, there is arranged a radial filter for filtering dirt particles out of the fluid flow. The guide sleeve may be calked in the stepped bore of the valve block by means of a fastening bushing.

EP 0 073 886 B1 has disclosed a hydraulic control unit with a control slide which is displaceable axially into multiple switching positions and which automatically returns into one of its switching positions by means of a resetting spring, which control slide, outside said switching position, can be fixed by means of a spring-loaded detent which engages into detent positions, which detent is furthermore hydraulically actuatable by means of a part which is guided as a piston in a housing bore and which can be acted on via an adjoining ring-shaped chamber with pressurized fluid. The ring-shaped chamber is connected via a pilot control valve to the pump pressure line that leads to the consumer, which pump pressure line is relieved of pressure when the one or more consumers are deactivated. Here, the hydraulic actuating travel of the detent is limited in relation to its actuating travel that is possible counter to spring force, and the detent locations on the control slide for the detent to engage into or behind are dimensioned radially such that, irrespective of the actuating travel that is possible counter to spring force, a hydraulic release of the detent is possible only at the detent positions provided for this.

### DISCLOSURE OF THE INVENTION

The solenoid valve for a hydraulic brake system having the features of independent patent claim 1 has the advantage that, in a solenoid valve with an electrically deenergized first operating state, a further electrically deenergized second operating state can be implemented. This means that embodiments of the present invention provide a bistable solenoid valve which can be switched between the two operating states as a result of application of a switching signal, wherein the solenoid valve remains permanently in the respective operating state until the next switching signal. Here, the first operating state may correspond to a closed position of the solenoid valve, and the second operating state may correspond to an open position of the solenoid valve. The switch between the two operating states may be performed for example by means of brief electrical energization of the active positioning element of the solenoid assembly or by means of application of a switching signal or electrical current pulse to the solenoid assembly. With such a short electrical energization, the energy consumption can be advantageously reduced in relation to a conventional solenoid valve with two operating states, which have only one electrically deenergized first operating state and which, in order to implement the electrically energized second operating state, must be electrically energized for the duration of the second operating state. Furthermore, by contrast to embodiments of the present invention, the functional reliability or functional availability is not provided to the desired extent if the function can be realized only by means of active electrical energization.

Embodiments of the present invention provide a solenoid valve for a hydraulic brake system, having a solenoid assembly, having a pole core, having a guide sleeve connected to the pole core, having a valve armature which is guided in axially movable fashion within the guide sleeve and which can be driven counter to the force of at least one resetting spring by a magnet force generated by the solenoid assembly or can be driven by the force of the at least one resetting spring and which axially moves a plunger with a closing element, and having a valve body which is connected to the guide sleeve and which has a valve seat which is arranged between at least one first flow opening and at least one second flow opening. Here, the plunger is mounted in axially movable fashion in the valve armature, wherein a mechanical detent device is formed between a positionally fixed guide component which is inserted into the guide sleeve, and the plunger, which mechanical detent device, in an electrically deenergized closed position, releases the plunger such that a first resetting spring pushes the closing element sealingly into the valve seat in order to perform a sealing function, and, in an electrically deenergized open position, fixes the plunger, counter to the force of the first resetting spring, in an axial detent position such that the closing element is lifted off from the valve seat. In the electrically deenergized closed position, the fluid flow between the at least one first flow opening and the at least one second flow opening is shut off, and in the electrically deenergized open position, the fluid flow between the at least one first flow opening and the at least one second flow opening is permitted.

Embodiments of the solenoid valve according to the invention advantageously provide very low leakage in the closed position and low energy consumption in the open position.

Also proposed is a hydraulic brake system for a vehicle, which hydraulic brake system comprises a master brake cylinder, a hydraulics unit and multiple wheel brakes. Furthermore the hydraulics unit comprises at least two brake circuits for brake pressure modulation in the wheel brakes. Here, the at least two brake circuits each have at least one solenoid valve according to the invention which, in the electrically deenergized open position, enables the brake pressure modulation in at least one associated wheel brake and, in the electrically deenergized closed position, encloses a present brake pressure in the at least one associated wheel brake.

The hydraulic brake system for a vehicle having the features of independent patent claim 15 has the advantage that, with little additional outlay, it is possible in a commonly provided hydraulics unit with ESP functionality to realize an additional function which can electrohydraulically enclose a present brake pressure in the corresponding wheel brake and hold this over a relatively long period of time with little energy requirement. This means that the existing pressure supply, the pipelines from the hydraulics unit to the wheel brakes and sensor and communication signals can be used not only for the ESP function and/or ABS function and/or ASR function but also for an electrohydraulic pressure-holding function in the wheel brakes. In this way, it is advantageously possible for costs, structural space, weight and cabling to be saved, with the positive effect that the complexity of the brake system is reduced.

Advantageous improvements of the solenoid valve for a hydraulic brake system as specified in independent patent claim 1 are possible by means of the measures and refinements detailed in the dependent claims.

It is particularly advantageous that the mechanical detent device is designed as a rotary cam mechanism which utilizes a circumferential force component in order to move the plunger with the closing element axially into the detent position and out of said detent position again, such that the closing element can easily switch between the two electrically deenergized positions as a result of application of a switching signal or electrical current pulse to the solenoid assembly. Proceeding from the electrically deenergized closed position, the closing element can switch from the electrically deenergized closed position into the electrically deenergized open position as a result of application of a switching signal. When a subsequent switching signal is applied, the closing element switches back from the electrically deenergized open position into the electrically deenergized closed position. Proceeding from the electrically deenergized open position, the closing element can switch from the electrically deenergized open position into the electrically deenergized closed position as a result of application of a switching signal. When a subsequent switching signal is applied, the closing element switches back from the electrically deenergized closed position into the electrically deenergized open position.

In an advantageous refinement of the solenoid valve, at an end facing toward the valve seat, a depression is formed into a main body of the valve armature, which depression partially receives the plunger and an armature insert. The first resetting spring may act between the positionally fixed guide component and the plunger, wherein the plunger may be guided radially in a first passage opening of the positionally fixed guide component and in a second passage opening of the armature insert and may be moved by the valve armature axially in the direction of the pole core and by the first resetting spring in the direction of the valve seat.

In a further advantageous refinement of the solenoid valve, the plunger may have a cylindrical main body on which a first guide geometry and a second guide geometry spaced apart in a longitudinal direction may be formed. During the axial movement of the plunger, the first guide geometry of the plunger may interact with a third guide geometry formed on the main body of the guide component, and the second guide geometry of the plunger may interact with a fourth guide geometry formed on the main body of the armature insert. The guide component may for example have a main body designed as a ring-shaped disk. The plunger, the armature insert and the guide component may preferably be produced as plastics components in an injection molding process. The parts may alternatively be produced by powder injection molding (PIM) or ceramic injection molding (CIM) or metal injection molding (MIM) etc. or by 3D printing. Furthermore, the plunger may, at its tip, be formed integrally as a closing element for the valve seat. Alternatively, the plunger may be of multi-part design and have for example an additional sealing element, such as for example an O-ring seal, which is arranged in the region of the closing element and which improves the sealing action in the closed position. Furthermore, a division of the plunger geometry into further parts is possible. The valve armature may have a cylindrical main body which may be guided radially on an inner wall of the guide sleeve. Furthermore, a cylindrical portion of the main body of the armature insert may be inserted into a corresponding portion of the depression of the valve armature and have the fourth guide geometry. The armature insert may have a fifth guide geometry which, during an axial movement of the valve armature, may interact with a sixth guide geometry of the main body of the positionally fixed guide component and axially guide the valve armature. Owing to the requirement for magnetic conductivity, the valve armature is produced from a magnetically conductive material for example in a drop forging process or by cutting. The pole core is likewise produced from a magnetically conductive material. The cylindrical portion of the main body of the armature insert may for example be pressed into the depression of the valve armature. The guide component may have multiple pressing-in webs distributed on the circumference, and be pressed into and fixed in the guide sleeve by way of said pressing-in webs.

In a further advantageous refinement of the solenoid valve, the fifth guide geometry may have at least two guide limbs which are attached to the cylindrical portion of the main body. The sixth guide geometry may comprise at least two openings in the main body of the positionally fixed guide component, the dimensions of which openings are adapted to the dimensions of the guide limbs. Here the at least two guide limbs may be inserted into in each case one of the openings and be guided axially therein during an axial movement of the valve armature.

In a further advantageous refinement of the solenoid valve, the first guide geometry may comprise multiple first protuberances with a uniform pitch on the circumference of the main body of the plunger, which protuberances each have a unilateral bevel. The third guide geometry of the positionally fixed guide component may have, on a wall of the first passage opening, axial grooves with a uniform angular pitch and with at least two different depths in a radial direction, wherein intermediate webs of the axial grooves may have unilateral bevels, which bevels are adapted to the unilateral bevels of the first protuberances of the plunger. Furthermore, the second guide geometry may comprise multiple second protuberances on a first end of the plunger, which second protuberances may be arranged with a uniform pitch, and so as to be offset with respect to the first protuberances, on the circumference of the main body of the plunger and each have a unilateral bevel. The second protuberances may be supported on the fourth guide geometry of the armature insert during the axial movement in the direction of the pole core, which fourth guide geometry may comprise, on the edge of the second passage opening of the armature insert, grooves which are formed in with a uniform angular pitch and which have bilateral bevels, which bevels are adapted to the unilateral bevels of the second protuberances of the plunger.

In a further advantageous refinement of the solenoid valve, during an axial movement, effected by magnetic force of the solenoid assembly, in the direction of the pole core, the valve armature may drive along the inserted armature insert and, by means of the grooves of the armature insert, the plunger by way of its second protuberances, wherein, during the axial movement in the direction of the pole core, a circumferential force may act on the plunger by means of the bevels of the grooves and the bevels of the second protuberances of the plunger, which circumferential force seeks to rotate the plunger about its longitudinal axis. Here, the simultaneous guidance of the first protuberances of the plunger in the axial grooves of the positionally fixed guide component and/or of the guide webs of the armature insert in the openings of the positionally fixed guide component may prevent said rotational movement until the plunger reaches a predefined axial stroke and the first protuberances of the plunger exit the axial grooves of the positionally fixed guide component and, owing to the circumferential force that continues to act, can slide deeper into the grooves. Furthermore, owing to the unilateral bevels formed on the intermediate webs of the axial grooves, the second protuberances of the plunger may slide into the next axial grooves of the positionally fixed guide component and follow the new guide by means of a radial movement if the axial stroke of the valve armature and of the plunger reduces owing to the acting spring force of the first resetting spring, wherein the second protuberances of the plunger simultaneously slide into the respectively next groove. It is thus for example possible, in the electrically deenergized open position, for at least two first protuberances of the plunger to be in each case held axially in an axial groove which is relatively shallow in a radial direction, wherein the bevels of the first protuberances may bear against second bevels which are formed on the edge of the relatively shallow axial grooves. In the electrically deenergized closed position, all of the first protuberances of the plunger may be guided in each case in an axial groove, which is relatively deep in a radial direction, until the closing element makes contact in the valve seat. The numbers and angular pitches of the various protuberances and grooves and the respective bevel angles may be expediently selected in a manner dependent on the dimensions of the solenoid valve in order, with a conventional magnetic axial air gap, to be able to cause the various stroke positions to be assumed by means of a magnetic force which is generated by a commercially available solenoid assembly. In the case of different conditions, the numbers, angular pitches, bevel angles etc. may be correspondingly adapted.

In a further advantageous refinement of the solenoid valve, between the valve armature and the pole core, there may be arranged a second resetting spring which can move the valve armature in the direction of the valve seat. The second resetting spring which acts with a closing action is preferably designed as a very soft compression spring and permanently pushes the valve armature in the electrically deenergized state into the respectively lowermost possible position in the direction of the valve seat. In this way, it is advantageously possible for an undefined position of the valve armature, sticking of the armature to the pole core, and rattling of the armature, or the like, to be prevented. Furthermore, into the main body of the valve armature, there may be formed a spring receptacle which can at least partially receive the second resetting spring.

In a further advantageous refinement of the solenoid valve, the plunger may be of multi-part design, wherein the main body of the plunger can be joined between the first and second guide geometry. It is thus possible for the plunger parts to be individually assembled and then for example joined together by means of a pin-bore press-fit connection.

In a further advantageous refinement of the solenoid valve, the armature insert may be of multi-part design. It is thus for example possible for the armature insert to have two ring halves which, prior to the insertion into the depression of the valve armature, are placed around the plunger and may slightly overlap. The armature insert halves surround the plunger preferably between its first and second protuberances.

Exemplary embodiments of the invention are illustrated in the drawing and will be discussed in more detail in the following description. In the drawing, the same reference designations are used to denote components or elements which perform identical or analogous functions.

### BRIEF DESCRIPTION OF THE DRAWINGS

FIG. 1 is a schematic perspective sectional illustration of an exemplary embodiment of a solenoid valve according to the invention in its electrically deenergized closed position.

FIG. 2 is a schematic perspective illustration of an exemplary embodiment of a plunger for the solenoid valve from FIG. 1.

FIG. 3 is a schematic perspective illustration of an exemplary embodiment of a guide component for the solenoid valve from FIG. 1.

FIG. 4 shows a schematic perspective illustration of the plunger from FIG. 2 inserted into the guide component from FIG. 3.

FIG. 5 is a schematic perspective sectional illustration of an exemplary embodiment of an armature insert for the solenoid valve from FIG. 1.

FIG. 6 is a schematic perspective sectional illustration of the plunger from FIG. 2 inserted partially into the armature insert from FIG. 5 and the guide component from FIG. 3.

FIG. 7 is a schematic perspective sectional illustration of the solenoid valve according to the invention from FIG. 1 in its electrically deenergized open position.

FIG. 8 shows a schematic hydraulic circuit diagram of an exemplary embodiment of a hydraulic brake system according to the invention for a vehicle.

### EMBODIMENTS OF THE INVENTION

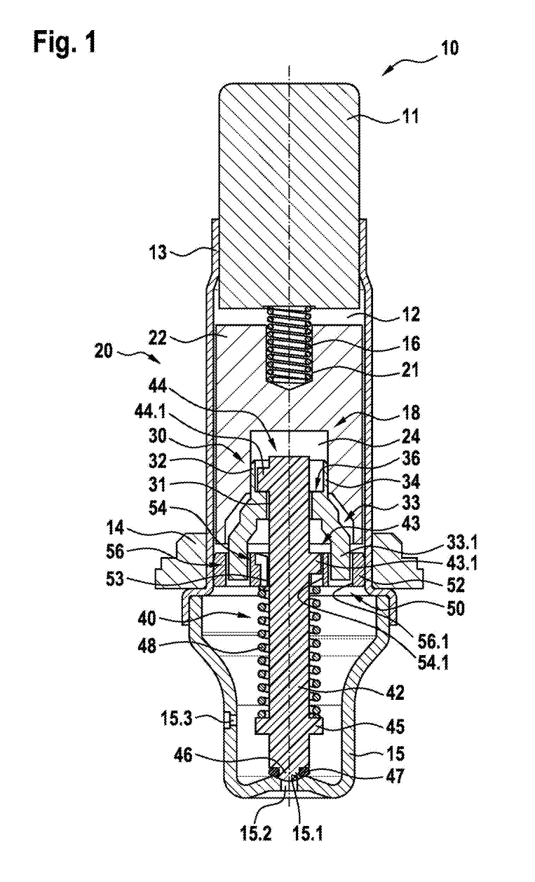

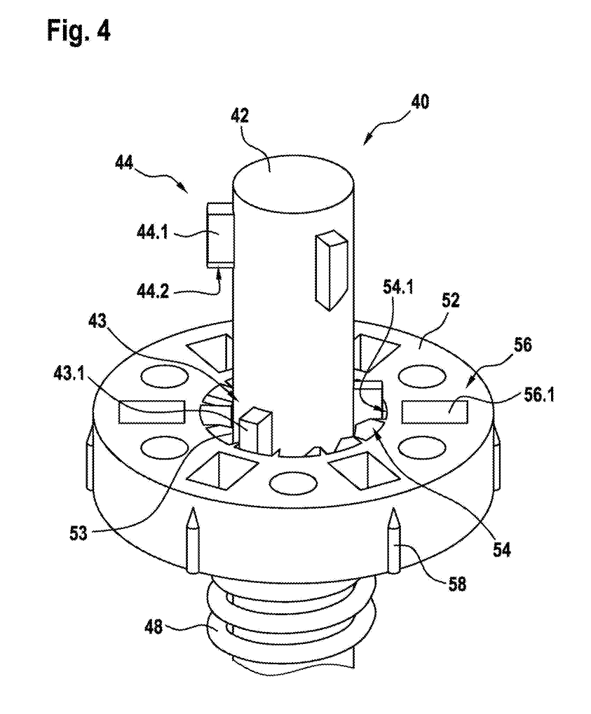

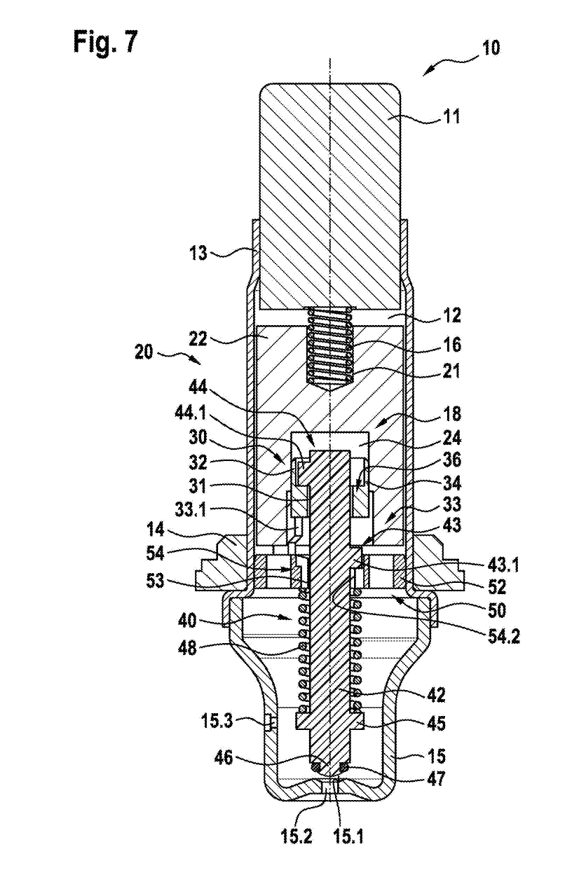

As can be seen from FIGS. 1 to 7, the illustrated exemplary embodiment of a solenoid valve 10 according to the invention for a hydraulic brake system 1 comprises a solenoid assembly (not illustrated), a pole core 11, a guide sleeve 13 connected to the pole core 11, a valve armature 20 which is guided in axially movable fashion within the guide sleeve 13 and which can be driven counter to the force of at least one resetting spring 16, 48 by a magnet force generated by the solenoid assembly or can be driven by the force of the at least one resetting spring 16, 48 and which axially moves a plunger 40 with a closing element 46, and a valve body 15 which is connected to the guide sleeve 13 and which has a valve seat 15.1 which is arranged between at least one first flow opening 15.2 and at least one second flow opening 15.3. Here, the plunger 40 is mounted in axially movable fashion in the valve armature 20, wherein a mechanical detent device 18 is formed between a positionally fixed guide component 50 which is inserted into the guide sleeve 13, and the plunger 40, which mechanical detent device, in an electrically deenergized closed position illustrated in FIG. 1, releases the plunger 40 such that a first resetting spring 48 pushes the closing element 46 sealingly into the valve seat 15.1 in order to perform a sealing function and shuts off a fluid flow between the at least one first flow opening 15.2 and the at least one second flow opening 15.3, and, in an electrically deenergized open position illustrated in FIG. 7, fixes the plunger 40, counter to the force of the first resetting spring 48, in a first axial detent position such that the closing element 46 is lifted off from the valve seat 15.1 and the fluid flow between the at least one first flow opening 15.2 and the at least one second flow opening 15.3 is permitted. In this way, a bistable solenoid valve 10 is implemented which can be switched between the two positions as a result of application of a switching signal, wherein the solenoid valve 10 remains permanently in the respective operating state until the next switching signal.

A bistable solenoid valve 10 of said type may be used for example in a hydraulic brake system 1 for a vehicle.

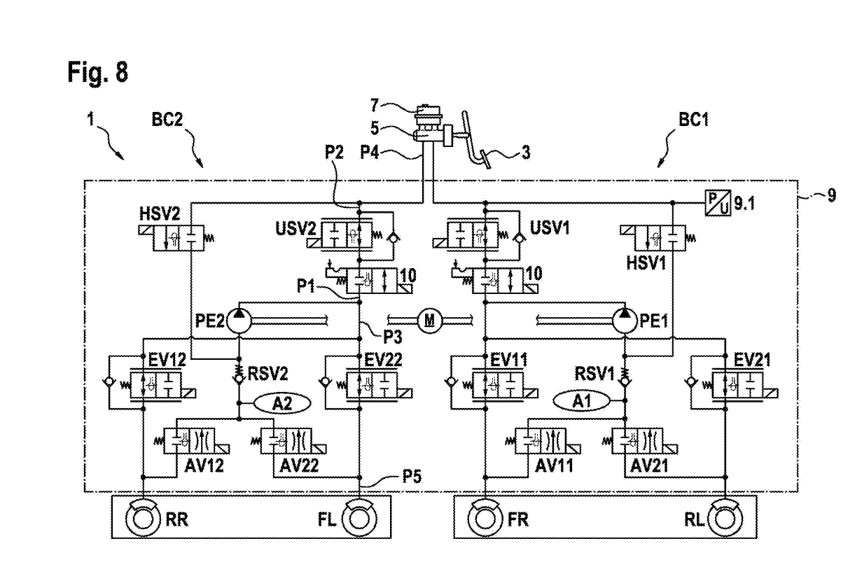

As can be seen from FIG. 8, the illustrated exemplary embodiment of a hydraulic brake system 1 according to the invention for a vehicle, with which various safety functions can be implemented, comprises a master brake cylinder 5, a hydraulics unit 9 and multiple wheel brakes RR, FL, FR, RL. The hydraulics unit 9 comprises at least two brake circuits BC1, BC2 for brake pressure modulation in the wheel brakes RR, FL, FR, RL. Here, the at least two brake circuits BC1, BC2 each have a bistable solenoid valve 10 which has an electrically deenergized closed position and an electrically deenergized open position and which is switchable between the two positions, wherein the bistable solenoid valve 10, in the electrically deenergized open position, enables the brake pressure modulation in at least one associated wheel brake RR, FL, FR, RL and, in the electrically deenergized closed position, encloses a present brake pressure in the at least one associated wheel brake RR, FL, FR, RL.

As can also be seen from FIG. 8, the illustrated exemplary embodiment of the hydraulic brake system 1 comprises two brake circuits BC1, BC2, which are assigned in each case two of the fourth wheel brakes RR, FL, FR, RL. Thus, a first wheel brake FR, which is arranged for example on the right-hand side at a vehicle front axle, and a second wheel brake RL, which is arranged for example at the left-hand side at a vehicle rear axle, are assigned to a first brake circuit BC1. A third wheel brake RR, which is arranged for example at the right-hand side at a vehicle rear axle, and a fourth wheel brake FL, which is arranged for example at the left-hand side at the vehicle front axle, are assigned to a second brake circuit BC2. Each wheel brake RR, FL, FR, RL is assigned an inlet valve EV11, EV21, EV12, EV22 and an outlet valve AV11, AV21, AV12, AV22, wherein, via the inlet valves EV11, EV21, EV12, EV22, pressure can be built up in the corresponding wheel brake RR, FL, FR, RL in each case, and wherein, via the outlet valves AV11, AV21, AV12, AV22, pressure can be dissipated in the corresponding wheel brake RR, FL, FR, RL in each case. For the build-up of pressure in the respective wheel brake RR, FL, FR, RL, the corresponding inlet valve EV11, EV21, EV12, EV22 is opened and the corresponding outlet valve AV11, AV21, AV12, AV22 is closed. For the dissipation of pressure in the respective wheel brake RR, FL, FR, RL, the corresponding inlet valve EV11, EV21, EV12, EV22 is closed and the corresponding outlet valve AV11, AV21, AV12, AV22 is opened.

As can also be seen from FIG. 8, the first wheel brake FR is assigned a first inlet valve EV11 and a first outlet valve AV11, the second wheel brake RL is assigned a second inlet valve EV21 and a second outlet valve AV21, the third wheel brake RR is assigned a third inlet valve EV12 and a third outlet valve AV12, and the fourth wheel brake FL is assigned a fourth inlet valve EV22 and a fourth outlet valve AV22. By means of the inlet valves EV11, EV21, EV12, EV22 and the outlet valves AV11, AV21, AV12, AV22, open-loop and/or closed-loop control processes can be performed in order to implement an ABS function.

Furthermore, the first brake circuit BC1 has a first intake valve HSV1, a first system pressure setting valve USV1, a first expansion tank Al with a first check valve RSV1, and a first fluid pump PE1. The second brake circuit BC2 has a first intake valve HSV2, a second system pressure setting valve USV2, a second expansion tank A2 with a second check valve RSV2, and a second fluid pump PE2, wherein the first and second fluid pumps PE1, PE2 are driven by a common electric motor M. Furthermore, the hydraulics unit 9 comprises a sensor unit 9.1 for determining the present system pressure or brake pressure. For the brake pressure modulation and to implement an ASR function and/or an ESP function, the hydraulics unit 9 uses the first system pressure setting valve USV1, the first intake valve HSV1 and the first return delivery pump PE1 in the first brake circuit BC1, and the second system pressure setting valve USV2, the second intake valve HSV2 and the second return delivery pump PE2 in the second brake circuit BC2. As can also be seen from FIG. 8, each brake circuit BC1, BC2 is connected to the master brake cylinder 5, which can be actuated by means of a brake pedal 3. Furthermore, the fluid tank 7 is connected to the master brake cylinder 5.

The intake valves HSV1, HSV2 permit an intervention into the brake system without the presence of a driver demand. For this purpose, by means of the suction valves HSV1, HSV2, the respective suction path for the corresponding fluid pump PE1, PE2 to the master brake cylinder 5 is opened, such that said fluid pump instead of the driver can provide the pressure required for the closed-loop control. The system pressure setting valves USV1, USV2 are arranged at the master brake cylinder 5 and at least one associated wheel brake RR, FL, FR, RL and set the system pressure or brake pressure in the associated brake circuit BC1, BC2. As can also be seen from FIG. 8, a first system pressure setting valve USV1 sets the system pressure or brake pressure in the first brake circuit BC1 and a second system pressure setting valve USV2 sets the system pressure or brake pressure in the second brake circuit BC2.

As can also be seen from FIG. 8, the bistable solenoid valves 10 may be incorporated into the respective brake circuit BC1, BC2 at various positions P1, P2, P3, P4, P5. In the exemplary embodiments illustrated, the various positions P1, P2, P3, P4, P5 are indicated in each case in the second brake circuit BC2. As can also be seen from FIG. 8, the bistable solenoid valves 10 are incorporated into the respective brake circuit BC1, BC2 in each case at a first position P1 between the corresponding system pressure setting valve USV1, USV2 and the inlet valves EV11, EV12, EV21, EV22 upstream of an outlet channel of the corresponding fluid pump PE1, PE2. Alternatively, the bistable solenoid valves 10 may be incorporated into the respective brake circuit BC1, BC2 in each case at a second position P2 between the master brake cylinder 5 and the corresponding system pressure setting valve USV1, USV2, directly upstream of the corresponding system pressure setting valve USV1, USV2. As a further alternative arrangement, the bistable solenoid valves 10 may be incorporated into the respective brake circuit BC1, BC2 in each case at a third position P3 between the corresponding system pressure setting valve USV1, USV2 and the inlet valves EV11, EV12, EV21, EV22 downstream of the outlet channel of the fluid pump PE1, PE2. Furthermore, in a further alternative arrangement, the bistable solenoid valves 10 may be incorporated into the respective brake circuit BC1, BC2 in each case at a fourth position P4 between the master brake cylinder 5 and the corresponding system pressure setting valve USV1, USV2 in the common fluid branch directly downstream of the master brake cylinder 5. Furthermore, the bistable solenoid valves 10 may be incorporated into the respective brake circuit BC1, BC2 in each case at a fifth position P5 directly upstream of an associated wheel brake RR, FL, FR, RL.

As can also be seen from FIG. 8, in the illustrated exemplary embodiment of the hydraulic brake system 1, an electrical energy store in the form of a vehicle on-board electrical system is used in order to keep the brake pressure which is enclosed in the at least one associated wheel brake RR, FL, FR, RL in the electrically deenergized closed position of the bistable solenoid valve 10 constant by replenishment delivery of brake fluid by means of the fluid pump PE1, PE2. Since electrical energy is required only for the switching of valves and for the brief replenishment delivery function, there is only a small additional electrical energy requirement for the brake pressure maintaining function. Alternatively, in an exemplary embodiment which is not illustrated, hydraulic accumulator devices may be used in order to keep the brake pressure which is enclosed in the at least one associated wheel brake RR, FL, FR, RL in the electrically deenergized closed position of the bistable solenoid valve 10 constant by replenishment delivery of brake fluid. Since electrical energy is required only for the switching of valves, but virtually no electrical energy is required for the replenishment delivery function, there is an even smaller electrical energy requirement for the brake pressure maintaining function owing to the hydraulic accumulator devices.

By means of the described measures, a compensation of any internal leakage and volume expansions which may arise for example owing to temperature changes is possible in an advantageous manner. Furthermore, the described measures may be combined. This means that the hydraulic accumulator device may be combined with the electrical accumulator device in order, in the electrically deenergized closed position of the bistable solenoid valve 10, to keep the brake pressure enclosed in the at least one associated wheel brake RR, FL, FR, RL constant over a relatively long period of time by replenishment delivery of brake fluid.

As can also be seen from FIGS. 1 to 7, the mechanical detent device 18 is designed as a rotary cam mechanism, which utilizes a circumferential force component in order to move the plunger 40 with the closing element 46 axially into the detent position and out of said detent position again, such that the closing element 46 can switch between the two electrically deenergized positions as a result of application of a switching signal or current pulse to the solenoid assembly.

As can also be seen from FIGS. 1 to 7, at an end facing toward the valve seat 15.1, a depression 24 is formed into a main body 22 of the valve armature 20, which depression partially receives the plunger 40 and an armature insert 30. The first resetting spring 48 acts between the positionally fixed guide component 50 and the plunger 40. The plunger 40 is guided radially in a first passage opening 53 of the positionally fixed guide component 50 and in a second passage opening 31 of the armature insert 30 and is movable by the valve armature 20 axially in the direction of the pole core 30 and by the first resetting spring 48 in the direction of the valve seat 15.1.

As can also be seen from FIGS. 1 to 7, the plunger 40 has a cylindrical main body 42 on which a first guide geometry 43 and a second guide geometry 44 spaced apart in a longitudinal direction are formed. During the axial movement of the plunger 40, the first guide geometry 43 of the plunger 40 interacts with a third guide geometry 54 formed on the main body 52 of the guide component 50. The second guide geometry 44 of the plunger 40 interacts with a fourth guide geometry 36 formed on the main body 32 of the armature insert 30. The first resetting spring 48 is designed as a spiral spring and is pushed onto the plunger 40. In the installed state, the first resetting spring 48 is supported on a surface, facing toward the valve seat 15.1, of the guide component 50 and on an encircling ring-shaped collar 45 arranged on the main body 42 of the plunger 40. Alternatively, the first resetting spring 48 may be arranged in the depression 24 of the armature 20 and be supported on an end surface of the plunger 40 and on the base of the depression 24.

In the exemplary embodiment illustrated, the valve armature 20 has a cylindrical main body 22 which is guided radially on an inner wall of the guide sleeve 13. A cylindrical portion 34 of the main body 32 of the armature insert 30 is inserted into a corresponding portion of the depression 24 of the valve armature 20 and has the fourth guide geometry 36. The armature insert 30 has a fifth guide geometry 33 which, during an axial movement of the valve armature 20, interacts with a sixth guide geometry 56 of the main body 52 of the positionally fixed guide component 50 and axially guides the valve armature 20. Owing to the requirement for magnetic conductivity, the valve armature 20 and the pole core 11 are, in the exemplary embodiment illustrated, produced from magnetically conductive metal in a drop forging process or by cutting.

In the exemplary embodiment illustrated, the fifth guide geometry 33 has at least two guide limbs 33.1 which are attached, lying opposite one another, to the cylindrical portion 34 of the main body 32. The sixth guide geometry 56 comprises at least two openings 56.1 in the main body of the positionally fixed guide component 50, the dimensions of which openings are adapted to the dimensions of the guide limbs 33.1, wherein the two guide limbs 33.1 are inserted in each case into one of the openings 56.1 and are guided axially therein during an axial movement of the valve armature 20. In the exemplary embodiment illustrated, the cylindrical portion 34 of the main body 32 of the armature insert 30 is pressed into the corresponding portion of the depression 24 of the valve armature 20, such that a rotationally conjoint connection is formed between the armature insert 30 and the valve armature 20. In the exemplary embodiment illustrated, the armature insert 30 is designed as a plastics injection-molded part. Alternatively, the armature insert 30 may be produced in a PIM, CIM or MIM process or as a 3D-printed part.

As can also be seen from FIGS. 1 to 7, the first guide geometry 43 comprises multiple first protuberances 43.1 with a uniform pitch on the circumference of the main body 42 of the plunger 40, which protuberances each have a unilateral bevel 43.2. The third guide geometry 54 of the positionally fixed guide component 50 has, on a wall of the first passage opening 53, axial grooves 54.1, 54.2 with a uniform angular pitch and with at least two different depths in a radial direction, wherein intermediate webs 54.4 of the axial grooves 54.1, 54.2 have unilateral bevels 54.5, which bevels are adapted to the unilateral bevels 43.2 of the first protuberances 43.1 of the plunger 40. Owing to the complex geometry, the guide component 50 is likewise designed as a plastics injection-molded part. Alternatively, the guide component 50 may be produced in a PIM, CIM or MIM process or as a 3D-printed part.

The second guide geometry 44 comprises multiple second protuberances 44.1 on a first end of the plunger 40, which second protuberances are arranged with a uniform angular pitch, and so as to be offset with respect to the first protuberances 43.1, on the circumference of the main body 42 of the plunger 40 and each have a unilateral bevel 44.2. The second protuberances 44.1 are supported on the fourth guide geometry 36 of the armature insert 30 during the axial movement in the direction of the pole core 11. The fourth guide geometry 36 comprises, on the edge of the second passage opening 31 of the armature insert 30, grooves 36.1 which are formed in with a uniform angular pitch and which have bilateral bevels 36.2, which bevels are adapted to the unilateral bevels 44.2 of the second protuberances 44.1 of the plunger 40. Formed on the other end of the plunger 40 is the closing element 46, which forms the tip of the plunger 40 and which interacts with the valve seat 15.1 in order to perform the sealing function. In the exemplary embodiment illustrated, the plunger 40 is designed as a plastics injection-molded part. Alternatively, the plunger 40 may be produced in a PIM, CIM or MIM process or as a 3D-printed part. Furthermore, a sealing element 47 is arranged on the closing element 46 in order to improve the sealing action in the valve seat 15.1. In the exemplary embodiment illustrated, the sealing element is designed as an O-ring seal.

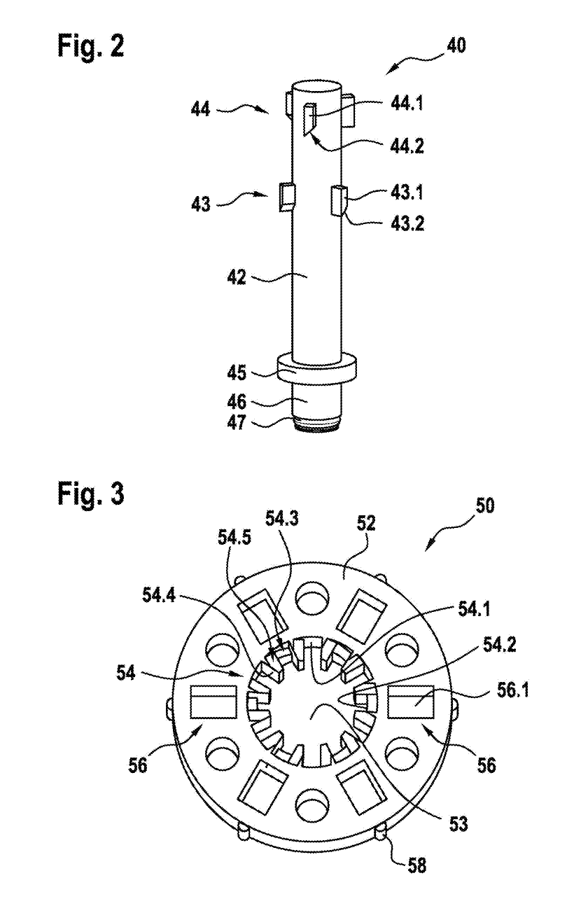

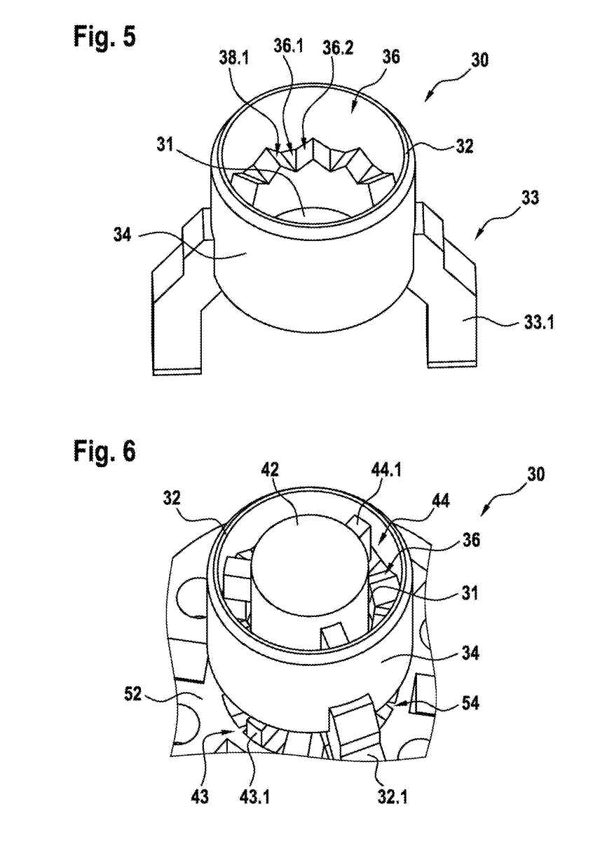

As can also be seen in particular from FIG. 2, in the exemplary embodiment illustrated, three first protuberances 43.1 with a 3×120° angular pitch are formed on the main body 42 of the plunger 40. Furthermore, in the exemplary embodiment illustrated, three second protuberances 44.1 with a 3×120° angular pitch are formed on the first end of the main body 42 of the plunger 40, which second protuberances are in each case offset by 60° in relation to the first protuberances 43.1. As can also be seen in particular from FIG. 3, in the exemplary embodiment illustrated, six deep first axial grooves 54.1 with an angular pitch of 6×60° are arranged on the wall of the first passage opening 53, which first axial grooves alternate with six shallow second axial grooves 54.2 with an angular pitch of 6×60°. As can also be seen from FIGS. 5 and 6, twelve grooves 36.1 with bilateral bevels 36.2 and with a 12×30° angular pitch are formed on the edge of the second passage opening 31. As can also be seen from FIG. 6, the bevels 44.2 at one side of the second protuberances 44.1 of the plunger bear in each case against a bevel 36.2 of corresponding grooves 36.1 of the armature insert 30. As can also be seen from FIG. 3, six openings 56.1 with an angular pitch of 6×60° are formed in the main body 52 of the guide component 50, although only two openings 56.1 with an angular pitch of 2×180° are required for the axial guidance of the two guide limbs 33.1. Together with bores which are not designated in any more detail here, this permits optimized producibility as an injection molded part with approximately equal wall thicknesses.

As can also be seen from FIG. 1, the first protruberances 43.1 of the plunger 10 are guided in the deep first axial grooves 54.1 in the main body 52 of the guide component 50, such that the first resetting spring pushes the closing element 46, by the plunger 40, sealingly into the valve seat 15.1 in order to perform a sealing function and shuts off a fluid flow between the at least one first flow opening 15.2 and the at least one second flow opening 15.3. If the valve armature 20 is attracted axially toward the immovable pole core 11 owing to an electromagnetic action, then the armature insert 30 arranged immovably with respect to the valve armature 20, by means of the grooves 36.1 of said armature insert, drives along the plunger 40 by way of its second protuberances 44.1. During this stroke movement, a circumferential force is exerted on the plunger 40 by means of the bevels 36.2 on the grooves 36.1 of the armature insert 30 and the bevels 44.2 on the second protuberances 44.1 of the plunger 40, which circumferential force seeks to rotate the plunger 40 about its longitudinal axis. This rotational movement is however initially prevented by the guidance of the first protuberances 43.1 of the plunger in the deep first axial grooves 54.1 of the guide component 50, which initially permit only a purely axial movement of the plunger 40. The rotational movement is also prevented by the axial guidance between the armature insert 30 and the guide component 50. Only when a certain axial stroke of the plunger 40 is overshot is the radial guidance of the first protuberances 43.1 of the plunger 40 in the first axial grooves 54.1 of the guide component 50 overshot, and the second protuberances 43.1 of the plunger 40 slide axially somewhat deeper into the grooves 36.1 of the armature insert 30 (tip into tip) owing to the circumferential force that continues to act. The plunger 40 is thus prevented from rotating further. If the axial stroke of valve armature 20, armature insert 30 and plunger 40 is subsequently reduced, the first protuberances 43.1 of the plunger 40 find their way, by way of their bevels 43.2, owing to the unilateral bevels 54.5 formed on the intermediate webs 54.4 of the axial grooves 54.1, 54.2, into the respectively next axial groove 54.2 of the guide component 50 and follow this new guide by means of a rotational movement. Here, the second protuberances 44.1 of the plunger 40 also slide in each case into the next groove 36.1 of the armature insert 30. The axial grooves 54.1, 54.2 of the guide component 50 are formed differently in terms of their radial extent. This means that every second axial groove 54.2 is designed to be radially shallower than its neighboring groove 54.1. If the first protuberances 43.1 of the plunger 40 now slide, as described above, into a relatively shallow second axial groove 54.2 of the guide component 50, then the plunger 40 can no longer follow the decreasing armature stroke, but rather remains engaged in the axial detent position which is predefined by bevels 54.3 formed on the edges of the second axial grooves 54.2, which bevels are adapted to the bevels 43.2 of the first protuberances 43.1. Distinct tip-on-tip positioning is thus realized, which is ensured by means of the first resetting spring 48, which continues to act with a closing action. Upon the next valve actuation, the valve armature 20 with armature insert 30 moves axially in the direction of pole core 11 again and, after the bevels 36.2 on the grooves 36.1 of the armature insert 30 make contact with the second protuberances 44.1 of the plunger 40, drives the plunger 40 along. As described above, the plunger 40 cannot rotate until the particular axial stroke is reached. When the particular axial stroke is reached, the plunger 40 rotates, and the second protuberances 44.1 of the plunger 40 slide deeper into the grooves 36.1 of the armature insert 30 (tip into tip). The plunger 40 is thus prevented from rotating further. If the axial stroke of valve armature 20, armature insert 30 and plunger 40 is subsequently reduced, the first protuberances 43.1 of the plunger 40 find their way, by way of their bevels 43.2, into the respectively next axial groove 54.1 of the guide component 50 and follow this new guide by means of a rotational movement. Here, the second protuberances 44.1 of the plunger 40 also slide in each case into the next groove 36.1 of the armature insert 30. Since the axial grooves 54.1, 54.2 of the guide component 50 are formed differently in terms of their radial extent, if the first protuberances 43.1 of the plunger 40 now slide in each case into a relatively deep first axial groove 54.1 of the guide component 50, then the plunger 40 can follow the decreasing armature stroke without limitation until the plunger 40 or the closing element 46 arrives in the valve seat 15.1 in the closed position.

As can also be seen from FIG. 7, in the electrically deenergized open position, the first protuberances 43.1 of the plunger 40 are in each case held axially in an axial groove 54.2 which is relatively shallow in a radial direction. Here, the bevels 43.2 of the first protuberances 43.1 bear against bevels 54.3 which are formed on the edge of the relatively shallow axial grooves 54.2.

As can also be seen from FIGS. 1 and 7, in the illustrated exemplary embodiment of the solenoid valve 10, between the valve armature 20 and the pole core 30, there is arranged a second resetting spring 16 which moves the valve armature 20 in the direction of the valve seat 15.1. This additional resetting spring 16 which acts with a closing action is preferably designed as a very soft compression spring and prevents the valve armature 20 from assuming an undefined position. In the exemplary embodiment illustrated, a blind bore is formed as a spring receptacle 21 into the main body 22 of the valve armature 20, which spring receptacle at least partially receives the second resetting spring 16. Alternatively, said blind bore for receiving the second resetting spring 16 may be formed into the pole core 11.

The above-stated numbers and angular pitches of the various protuberances 43.1, 44.1, guide limbs 33.1 and/or grooves 36.1, 54.1, 54.2 and the respective bevel angles may be correspondingly varied and adapted to the dimensions of the solenoid valve 10 in order, with a conventional magnetic axial air gap, to be able to cause the various stroke positions to be assumed with an expediently provided magnetic force.

To facilitate assembly, the plunger 40 may be of multi-part design. The division is preferably realized between the first and second protuberances 43.1, 44.1. The plunger parts are individually assembled and then joined together for example by means of a pin-bore press-fit connection. In this way, an unrestricted extraction function of the armature insert 30 for the plunger 40 is realized in any rotational angle position. Alternatively, the plunger 40 may be formed in one piece with its protuberances and be inserted into the armature insert 30 from below through new, continuous axial grooves in the armature insert 30 similar to the deep first axial grooves 54.1 of the guide component 50. Furthermore, the plunger 40 with its protuberances 43.1, 44.1 and a ring-shaped collar 45 of reduced diameter may be inserted from above through the armature insert 30. New continuous grooves are provided in the armature insert which are adapted to the angular pitch of the first protuberances 43.1. This angular pitch differs from the angular pitch of the second protuberances 43.2. In addition or alternatively, the second protuberances 44.1 may for example be designed to be thicker, or may be provided in greater number, in relation to the first protuberances 43.1, such that no undesired plunging through the new continuous axial grooves of the axial insert 30 is possible.

Furthermore, the armature insert 30 may be of multi-part design. It is thus for example possible for the armature insert 30 to have two ring halves which, prior to the insertion into the depression 24 of the valve armature 20, may be placed around the plunger 40 and may slightly overlap. The armature insert halves surround the plunger 40 preferably between its first and second protuberances 43.1, 44.1. Alternatively, the ring halves may for example be connected by means of an intensely deformable, integrally formed film hinge, which is opened as far as necessary in order for the plunger 40 to be received.

1. A solenoid valve for a hydraulic brake system, comprising:
a solenoid assembly;
a pole core;
a guide sleeve connected to the pole core;
a valve armature which is guided in axially movable fashion within the guide sleeve and which is configured to be driven counter to a spring force of at least one resetting spring by a magnet force generated by the solenoid assembly or is configured to be driven by the spring force of the at least one resetting spring, the valve armature configured to axially move a plunger with a closing element; and
a valve body connected to the guide sleeve, the valve body having a valve seat is arranged between at least one first flow opening and at least one second flow opening,
wherein the plunger is mounted in axially movable fashion in the valve armature, and
wherein a mechanical detent device is formed between a positionally fixed guide component which is inserted into the guide sleeve, and the plunger, the mechanical detent device, in an electrically deenergized closed position of the valve, releases the plunger such that a first resetting spring of the at least one resetting spring pushes the closing element sealingly into the valve seat to perform a sealing function, and, in an electrically deenergized open position of the valve, fixes the plunger, counter to the spring force of the first resetting spring, in an axial detent position such that the closing element is lifted off from the valve seat.

2. The solenoid valve as claimed in claim 1, wherein the mechanical detent device is configured as a rotary cam mechanism having a circumferential force component that moves the plunger with the closing element axially into the axial detent position and out of said axial detent position again, such that the closing element switches between the two electrically deenergized positions as a result of application of a switching signal to the solenoid assembly.

3. The solenoid valve as claimed in claim 2, wherein:
at an end facing toward the valve seat, a depression is defined in a main body of the valve armature, the depression partially receiving the plunger and an armature insert,
the first resetting spring acts between the positionally fixed guide component and the plunger, and
the plunger is guided radially in a first passage opening of the positionally fixed guide component and in a second passage opening of the armature insert and is is configured to be moved axially by the valve armature in a direction toward the pole core and by the first resetting spring in a direction toward the valve seat.

4. The solenoid valve as claimed in claim 3, wherein:
the plunger has a cylindrical main body on which a first guide geometry and a second guide geometry are formed in such a way that the first and second guide geometries are spaced apart in a longitudinal direction, and
during the axial movement of the plunger, the first guide geometry of the plunger interacts with a third guide geometry formed on the main body of the guide component, and the second guide geometry of the plunger interacts with a fourth guide geometry formed on the main body of the armature insert.

5. The solenoid valve as claimed in claim 4, wherein:
the valve armature has a cylindrical main body which is guided radially on an inner wall of the guide sleeve,
a cylindrical portion of the main body of the armature insert is inserted into a corresponding portion of the depression of the valve armature and has the fourth guide geometry, and
the armature insert has a fifth guide geometry which, during an axial movement of the valve armature, interacts with a sixth guide geometry of the main body of the positionally fixed guide component and axially guides the valve armature.

6. The solenoid valve as claimed in claim 5, wherein:
the fifth guide geometry has at least two guide limbs which are attached to the cylindrical portion of the main body,
the sixth guide geometry comprises at least two openings defined in the main body of the positionally fixed guide component, dimensions of the at least two openings are adapted to dimensions of the at least two guide limbs, and
each of the at least two guide limbs is inserted into a respective opening of the at least two openings and is guided axially in the respective opening during an axial movement of the valve armature.

7. The solenoid valve as claimed in claim 4, wherein:
the first guide geometry comprises multiple first protuberances with a uniform first pitch on a circumference of the main body of the plunger, the first protuberances each having a unilateral first bevel,
the third guide geometry of the positionally fixed guide component has, on a wall of the first passage opening, axial grooves with a uniform angular pitch and with at least two different depths in a radial direction, and
intermediate webs of the axial grooves have unilateral third bevels adapted to the unilateral first bevels of the first protuberances of the plunger.

8. The solenoid valve as claimed in claim 7, wherein:
the second guide geometry comprises multiple second protuberances on a first end of the plunger, the second protuberances are arranged with a uniform second pitch on the circumference of the main body of the plunger so as to be offset with respect to the first protuberances, each second protuberance having a unilateral second bevel and being supported on the fourth guide geometry of the armature insert during the axial movement in the direction of the pole core, which and
the fourth guide geometry comprises, on an edge of the second passage opening of the armature insert, grooves which are formed in with a uniform angular pitch and which have bilateral bevels, the bilateral bevels being adapted to the unilateral bevels of the second protuberances of the plunger.

9. The solenoid valve as claimed in claim 8, wherein:
during an axial movement, effected by magnetic force of the solenoid assembly, in the direction toward the pole core, the valve armature drives along the inserted armature insert and, via the grooves of the armature insert, the plunger by way of the second protuberances,
during the axial movement in the direction of the pole core, a circumferential force acts on the plunger via the bilateral bevels of the grooves and the second bevels of the second protuberances of the plunger, the circumferential force biasing the plunger to rotate about its a longitudinal axis of the plunger,
simultaneous guidance of at least one of (i) the first protuberances of the plunger in the axial grooves of the positionally fixed guide component and (ii) the guide limbs of the armature insert in the openings of the positionally fixed guide component prevents the rotation of the plunger about the longitudinal axis until the plunger reaches a predefined axial stroke and the first protuberances of the plunger exit the axial grooves of the positionally fixed guide component and, due to the circumferential force that continues to act, slide deeper into the grooves, wherein,
due to the unilateral third bevels formed on the intermediate webs of the axial grooves, the second protuberances of the plunger slide into the next adjacent axial grooves of the positionally fixed guide component and follow the new guide by means of a radial movement when the axial stroke of the valve armature and of the plunger reduces due to the spring force of the first resetting spring, and
the second protuberances of the plunger simultaneously slide into the respectively next adjacent groove.

10. The solenoid valve as claimed in claim 9, wherein,
in the electrically deenergized open position, at least two first protuberances of the plunger are in each case held axially in a respective one of the axial grooves which is relatively shallow in a radial direction,
the first bevels of the first protuberances bear against fourth bevels which are formed on the edge of the relatively shallow axial grooves, and
in the electrically deenergized closed position, all of the first protuberances of the plunger are guided in a respective relatively deep axial groove, which is relatively deep in a radial direction, until the closing element makes contact in the valve seat.

11. The solenoid valve as claimed in claim 1, wherein a second resetting spring is arranged between the valve armature and the pole core, the second resetting spring biasing the valve armature in the direction toward the valve seat.

12. The solenoid valve as claimed in claim 11, wherein a spring receptacle is defined into a main body (22) of the valve armature, the spring receptacle at least partially receiving the second resetting spring.

13. The solenoid valve as claimed in claim 4, wherein the plunger is of multi-part design, wherein the main body of the plunger is joined between the first and second guide geometry.

14. The solenoid valve as claimed in claim 5, wherein the armature insert is of multi-part design.

15. A hydraulic brake system for a vehicle, comprising:
a master brake cylinder;
a hydraulics unit; and
multiple wheel brakes,
wherein the hydraulics unit comprises at least two brake circuits for brake pressure modulation in the wheel brakes
wherein the at least two brake circuits each have at least one bistable solenoid valve comprising:
a solenoid assembly;
a pole core;
a guide sleeve connected to the pole core;
a valve armature which is guided in axially movable fashion within the guide sleeve and which is configured to be driven counter to a spring force of at least one resetting spring by a magnet force generated by the solenoid assembly or is configured to be driven by the spring force of the at least one resetting spring, the valve armature configured to axially move a plunger with a closing element and
a valve body connected to the guide sleeve, the valve body having a valve seat is arranged between at least one first flow opening and at least one second flow opening,
wherein the plunger is mounted in axially movable fashion in the valve armature,
wherein a mechanical detent device is formed between a positionally fixed guide component which is inserted into the guide sleeve, and the plunger, the mechanical detent device, in an electrically deenergized closed position of the valve, releases the plunger such that a first resetting spring of the at least one resetting spring pushes the closing element sealingly into the valve seat to perform a sealing function, and, in an electrically deenergized open position of the valve, fixes the plunger, counter to the spring force of the first resetting spring, in an axial detent position such that the closing element is lifted off from the valve seat, and
wherein, in the electrically deenergized open position, the at least one bistable solenoid valve enables the brake pressure modulation in at least one associated wheel brake and, in the electrically deenergized closed position, encloses a present brake pressure in the at least one associated wheel brake.
